(19) United States
(12) Patent Application Publication
(10) Pub. No.: US 2003/0005566 A1
(43) Pub. Date: Jan. 9, 2003

(54) Method and apparatus for assembling and packing small-sized articles

(76) Inventors: Bernd Kuehnast, Dresden (DE); Siegmund Bodach, Dresden (DE); Hartmut Freitag, Dresden (DE); Jochen Hagedorn, Dresden (DE)

Correspondence Address: Lawrence E. Laubscher, Sr., EFS Customer No. 30267311, Suite 300, 745 South 23rd Street, Arlington, VA, 22202-2451, US

(21) Appl. No.: 10/175,824

(22) Filed: Jun. 21, 2002

(30) Foreign Application Priority Data
Jun. 25, 2001 (DE) 101 30 533.8

(51) Int. Cl. B23P 11/00

(52) U.S. Cl. 29/430; 29/785; 29/792

(57) ABSTRACT

The present invention relates to a method for assembling and packing small-sized articles consisting of at least two components. A first component is here supplied to a handling device; a second component is assigned to the first component. The article which has been assembled from the first and second components is then packed. Being held between an input position and a discharge position by the handling device, the first component is guided by controllable pairs of gripper means along a curved path, the first components being received in the input position, guided along the curved path and transferred in the discharge position by the pairs of gripper means of the handling device to a transfer means. The second component is also supplied to the handling device, isolated and connected to the first component.

The present invention relates to a method and an apparatus for assembling and packing small-sized articles according to the preambles of patent claims 1 and 15.

Such an apparatus is known from EP 1 048 569 A2, wherein a first component of an article consisting of two components is guided by a conveyor belt without any spacing and along a linear transportation direction to a second conveying means. The second conveying means comprises an endless chain guided on two chain wheels, a lower carrier being secured to the chain for carrying the first component and an upper carrier for carrying the second component. The first components are spaced apart by means of the lower carrier. The upper carrier comprises recesses for receiving the second components. An alignment of the first and second components relative to one another is realized by an arrangement of the lower and upper carriers. The first and second components which are aligned relative to one another are joined to form an article by a third conveying means which comprises press means for connecting the first and second components.

Hence, there is the drawback that a conveyor belt as well as two endless chains must be driven and synchronized. Moreover, since the first component is arranged between the lower and upper carriers and the first components are spaced apart with the help of the first carrier, it is difficult to establish an adhesive connection between first and second components. An increase in machine output is restricted because of the above-mentioned structure of the apparatus according to EP 1 048 569 A3. Likewise, the linear supply requires an extensive spatial construction which is detrimental to a compact arrangement of the conveying units.

It is therefore the object of the present invention to provide a method for assembling and packing small-sized articles, wherein an article consisting of a plurality of components can be assembled under gentle treatment of the article and of the individual components and can be supplied to a packing means.

According to the invention the above object is achieved by a method having the features of patent claim 1.

Preferably, the second component is integrally bonded to the first component by an adhesive.

It is advantageous when an optical quality control of the assembled article is carried out prior to packing by using a plurality of evaluation criteria. An article sorting is preferably performed such that an article is sorted out when at least one of the evaluation criteria is not satisfied. An optical control of the article can e.g. be carried out with an image analysis. A presence of both components in the article, a position of the second component in a recess of the first component and an intactness of the first component and the second component are used as evaluation criteria in a preferred embodiment.

Further advantageous embodiments of the method according to the invention are laid down in the remaining subclaims.

It is further the object of the invention to provide an apparatus for assembling and packing small-sized articles consisting of at least two components, wherein a compact construction being achieved together with a gentle handling of the components and of the articles as well as a high machine output.

In an apparatus of the above-mentioned type, said object is achieved according to the invention by the features of patent claim 15.

The assembling and packing apparatus according to the invention excels within a continuous assembling and packing process in that the articles are assembled by a movable, in particular rotating, assembling head, both the first component and the second component being separately supplied to said assembling head.

Further advantageous embodiments of the apparatus according to the invention are laid down in the remaining subclaims.

In the following, the invention is explained in greater detail with reference to embodiments in conjunction with the accompanying drawings, in which:

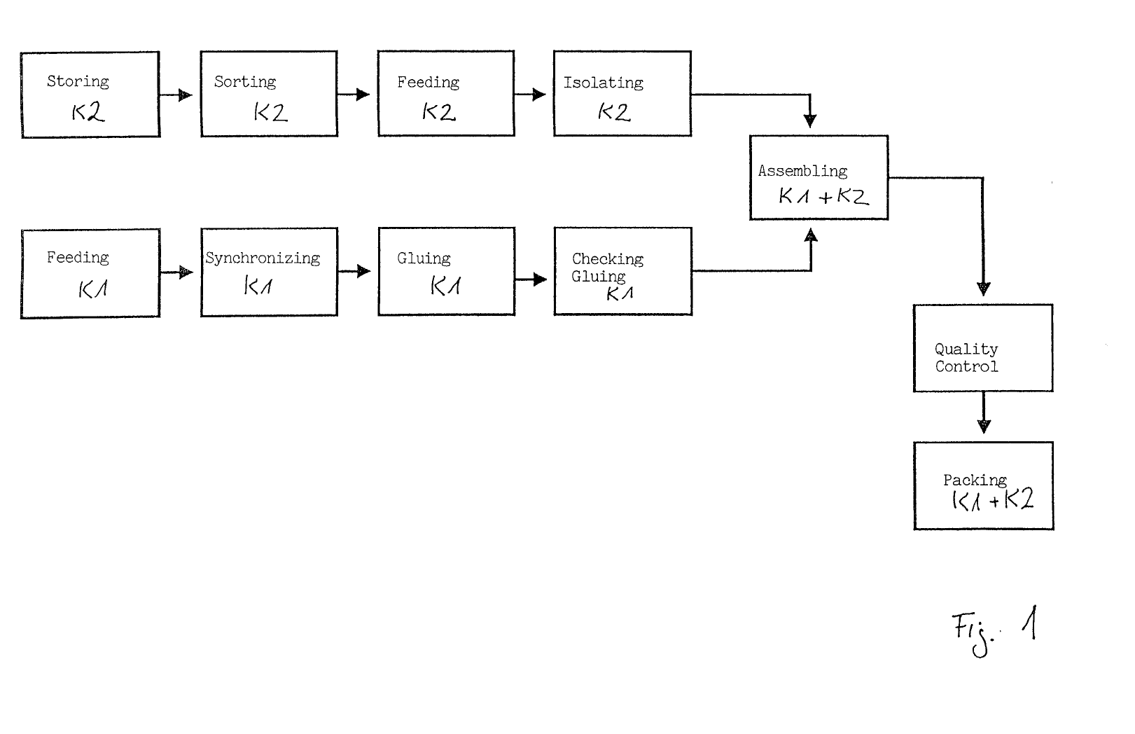

FIG. 1 shows a process sequence for assembling an article consisting of a first and a second component;

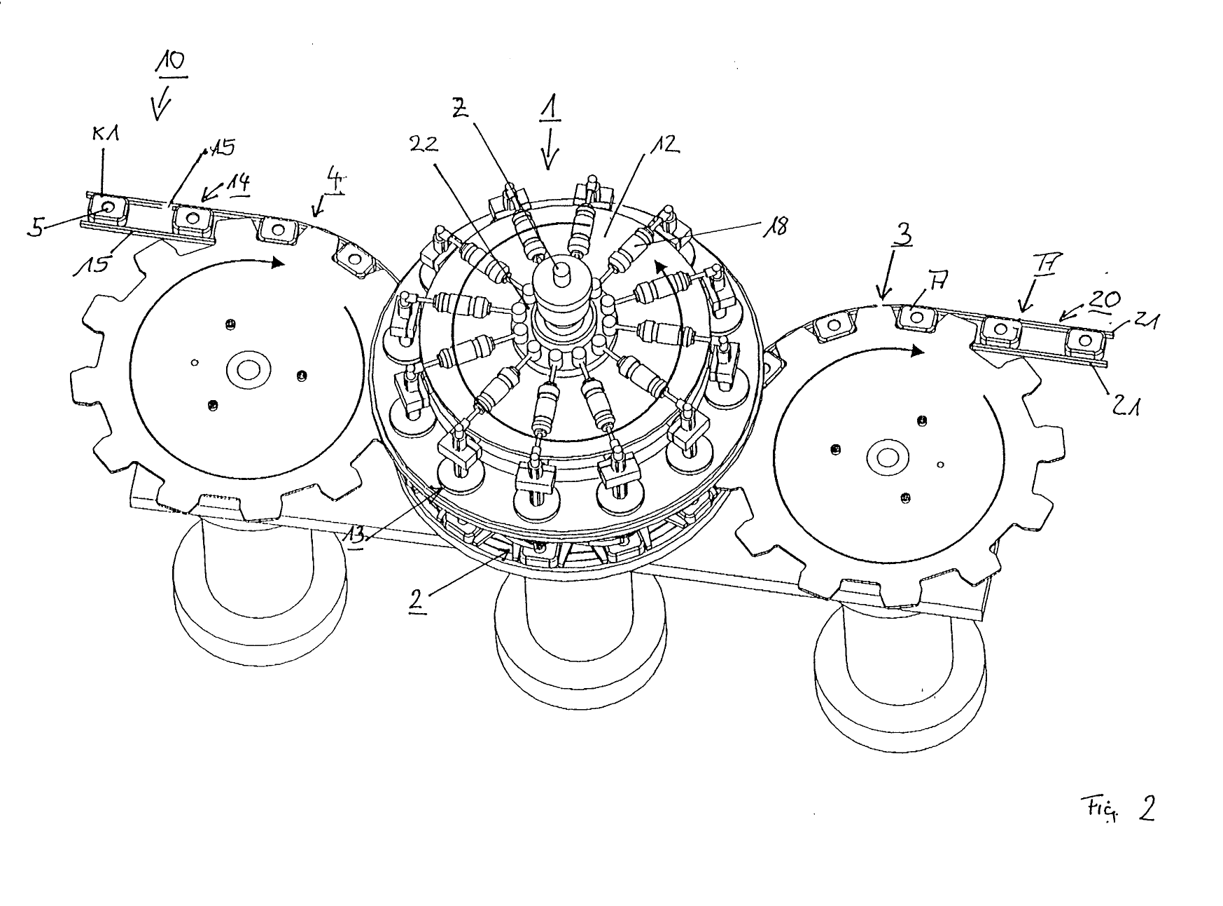

FIG. 2 is a schematic view showing part of an apparatus for assembling and packing small-sized articles consisting of at least two components each;

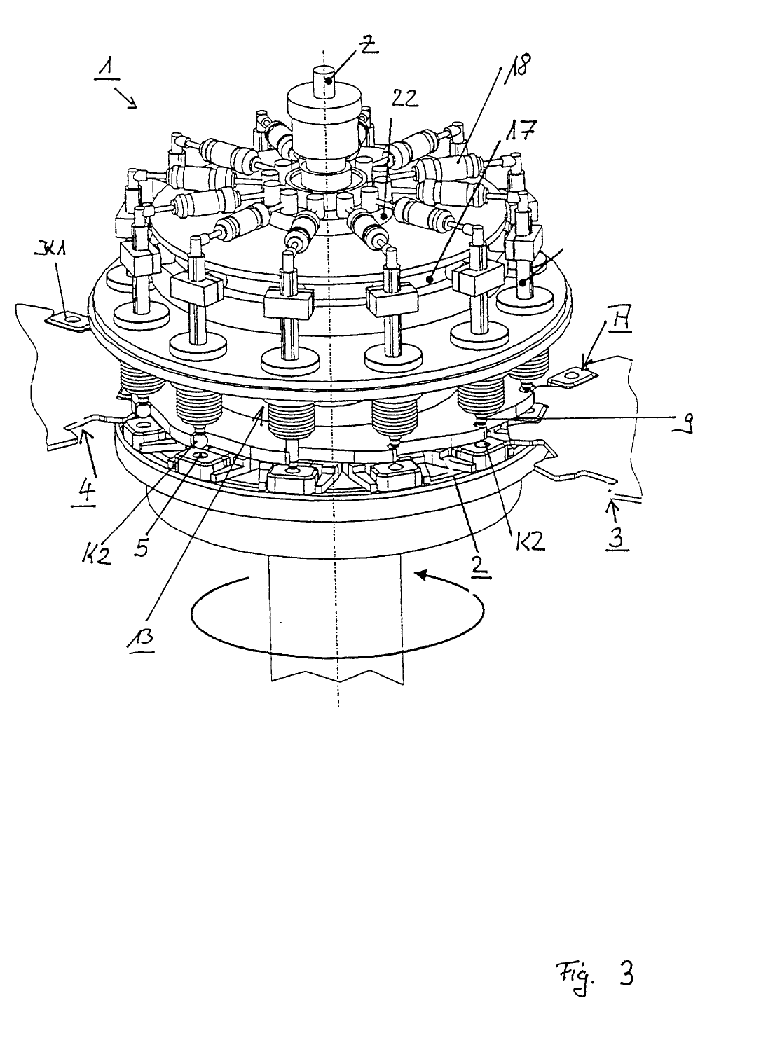

FIG. 3 is an enlarged sectional view of the apparatus for assembling and packing small-sized articles consisting of at least two components each, in accordance with FIG. 2; and

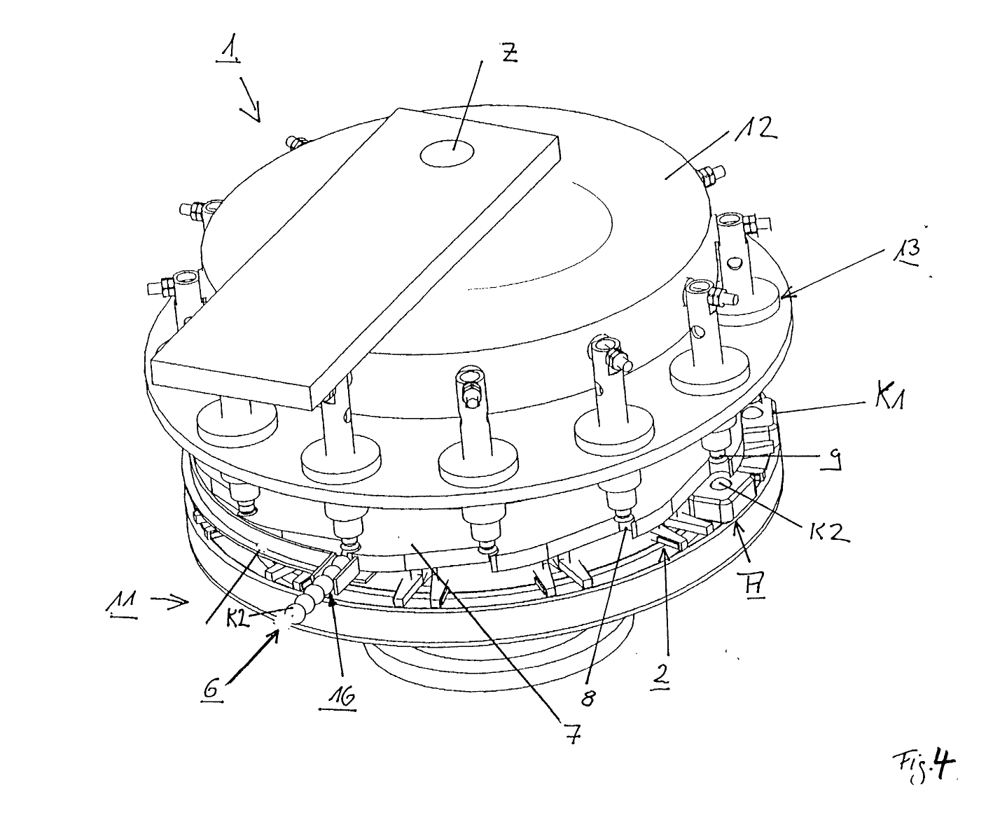

FIG. 4 is a partial view of an assembling head of the apparatus for assembling and packing small-sized articles consisting of at least two components each, in accordance with FIGS. 2 and 3.

A method for assembling and packing small-sized articles A consisting of at least two components K1, K2, as well as an apparatus for assembling and packing small-sized articles A consisting of at least two components K1, K2 each, shall now be explained in accordance with preferred embodiments taken in conjunction with FIGS. 1 to 4, wherein the apparatus in the present case is designed for assembling and packing a dish washer tab without being limited thereto. Hence, an outer contour of the components K1, K2 which are assembled to form an article A can be freely chosen without the need for essential changes to be made to the method or apparatus.

In the above-mentioned preferred embodiment, namely a dish washer tab, an article A is formed from a prismatically shaped basic body, in particular a cuboid with a recessed portion for at least partly receiving a second component K2. The second component K2 is preferably formed in rotational symmetry.

FIG. 1 schematically shows a process sequence for the separated supply of the first and second component K1, K2, the assembly of the article A formed from first and second component K1, K2, a quality control of the article A, and a packing of the article A in a joining and packing process. The article is here preferably packed in a flow pack machine.

According to the preferred method depicted in FIG. 1 for assembling and packing small-sized articles A consisting of at least two components K1, K2, the first component K1 is first fed to the process and synchronized prior to the assembly of article A; in this preferred embodiment, synchronization means a spacing at a predetermined graduation and an arrangement in a specific relative position, in particular relative to an input chain of the apparatus for assembling and packing small-sized articles A consisting of at least two components K1, K2 each.

The synchronized first components K1 are provided with an adhesive—preferably in the area of the recessed portion for at least partly receiving a second component K2 (“glued”).

Such a coating with an adhesive is advantageous for a bonding between the first and second components K1, K2, but not imperative for the described method, and the described method is thus not limited thereto. The small-sized article A consisting of first and second components K1, K2 can e.g. also be assembled by exclusively pressing the second component K2 into the recesses portion of the first component K1.

The adhesive applied in accordance with the above-described preferred embodiment is subsequently checked. A small-sized article A with an inadequate application of adhesive is sorted out in the further process of the method according to a further preferred embodiment. The sorting operation can be performed at various points in the course of the process; for instance, a first component K1 with an unsatisfactory application of adhesive can be sorted out after assembly with a second component K2 and thus prior to the packing step. Hence, according to the described preferred embodiment, the first components K1 are supplied to the assembling process independently of an assessment of the adhesive applied. Articles with an unsatisfactory application of adhesive are sorted out prior to packing of the assembled articles.

According to the preferred method depicted in FIG. 1 for assembling and packing small-sized articles A consisting of at least two components K1, K2, the stored second component K2 is supplied to the process after a sorting step and isolated.

The isolated second component K2 is combined with the glued first component K1 and assembled to form an article A (“K1+K2”). Following a subsequent quality control the articles A that satisfy the requirements of the quality control are packed.

FIG. 2 is a schematic illustration showing part of an apparatus for assembling and packing small-sized articles A consisting of at least two components each. The apparatus consists essentially of a feeding and synchronizing means (not shown in more detail here) including an input chain 14 with side guides 15 for the first component K1, an adhesive supply means for the first component K1, including a checking system for the satisfactory application of adhesive, a storage and supply means for the second component K2, a handling device 1 for assembling article A, an image processing system for controlling the quality of articles A, and a packing machine (not shown) for packing the checked article A, preferably in flow packs.

The first components K1 are supplied in series to the apparatus for assembling and packing small-sized articles A consisting of at least two components K1, K2 each, namely in ordered fashion lying on a transportation belt (not shown), and are accumulated on an accumulation belt of the feeding and synchronizing system. The first components K1 are then synchronized, i.e. spaced at a predetermined graduation and arranged in a specific relative position with respect to the input chain 14 of the apparatus for assembling and packing small-sized articles A consisting of at least two components K1, K2 each, so that the first components K1 can be taken over by carriers (not shown) of the input chain 14, the first components K1 being laterally guided by means of side guides 15. The lateral guiding of the first component K21 will only start after the first components have been taken over by the carriers of the input chain 14.

As shown in FIG. 2 for the preferred embodiment of the apparatus for assembling and packing small-sized articles A consisting of at least two components K1, K2 each, the first components K1 are transferred by the carriers of the input chain 14 into an input wheel 4, the first components K1 having an exactly definable position, in particular at the end of the input chain 14 and in the input wheel 4, respectively.

Thanks to said exact positioning and the also exactly definable position of the first components K1, the application of adhesive and, in the preferred embodiment, also a control of the adhesive applied can preferably be carried out in the area of the input chain 14 or in the area of the input wheel 4. Due to the improved accessibility in the area of the input chain 14, the preferably electrically operable application head for the application of adhesive and also a control sensor for the application of adhesive are in particular arranged in the area of the input chain 14. However, with a correspondingly constructional design, the application of adhesive and/or the control thereof can also be carried out without any limitation in the area of the input wheel 4.

Said application of adhesive, in particular in a gluing process, permits an integral bonding of first and second components K1, K2.

In a preferred embodiment, a trigger signal required for controlling the application of adhesive is produced by an optical sensor which is provided for detecting an edge of the first component K1. The trigger signal of the optical sensor is supplied to a distance controlling device. A preferably electrically operated application head for the application of adhesive is actuated by means of signals of the distance controlling device in combination with an incremental stepping means installed on the drive of the input chain 14 or the input wheel 4.

In the preferred embodiment a recess 5 which is exclusively formed in the first component K1 is coated with an adhesive for receiving the second component K2. The application of adhesive is then controlled with a further sensor, in the preferred embodiment with an infrared sensor.

If the control of the application of adhesive reveals an unsatisfactory or missing application of adhesive, the corresponding component K1 will automatically be removed from the apparatus. According to the described preferred embodiment, such a sorting out is only carried out after assembly of the small-sized articles A, but prior to packing in the area of a carrier chain of the packing means.

The first components K1 are transferred from the input wheel 4 to cam-controlled pairs of gripper means 2 of an assembling head 12 of the handling device 1. The assembling head 12 is shown in more detail in FIGS. 2, 3 and 4.

The second components K2 are transported by a belt bunker (not shown) via an elevator to a centrifugal conveyor, the elevator being controlled by determining a filling level of the centrifugal conveyor. The second components K2 pass from said centrifugal conveyor to the assembling head 12 by means of a supply means 11, which is an inclined supply rail 16 in the preferred embodiment schematically shown in FIG. 4. Sensors (not shown) are mounted on the inclined supply rail 16 for controlling the centrifugal conveyor and for controlling the flow of material of second components K2 during operation of the apparatus.

As can in particular be gathered from FIG. 4, the assembling head 12 comprises an isolating disk 7 with pocket-shaped recesses 8 for receiving the second component K2, the isolating disk 7 in the preferred embodiment being exchangeably arranged on the shaft. The isolating disk 7 is arranged in the vicinity of the inclined guide rail 16. Upstream of said isolating disk 7, the second components K2 are accumulated within the guide rail 16. The isolating disk 7 which rotates with the assembling head 12 respectively removes one second component K2 from said accumulation. Thanks to a special, curved geometrical design of a side surface of the isolating disk 7, which is in contact with the second component K2, a quasi-continuous movement of the second component K2 is achieved in the supply line of the second components K2, whereby the second component K2 is gently supplied to the assembling head 12, in particular, at a high feed rate.

A pneumatically operated stopper (not shown) is provided directly upstream of the isolating disk 7 of the assembling head in the illustrated preferred embodiment, the stopper being capable of interrupting a supply of the second component K2 to the assembling head 12, for instance in response to an operative state of the assembling head 12. On the basis of signals from the sensors mounted on the inclined supply rail 16, it is e.g. also possible to stop the system when the component flow is interrupted in the supply rail 16.

The second components K2 are taken over by the isolating disk 7 by means of cam-controlled suction plunger means 13, in particular vertical suction plunger means 13. The suction plunger means 13 comprise suction means to which a vacuum is applied by a central vacuum distributor 22 at least in the area where the second component K2 is taken over from the supply rail 16 up to a place where the second component K2 is pressed into the recess 5 of the first component K1 for receiving the second component K2.

In the described preferred embodiment shown in FIGS. 2, 3 and 4, the individual connections between the individual suction plunger means 13 and the central vacuum distributor 22 are each equipped with an air filter 18.

A further embodiment (not shown) does not include said air filters 18. According to said embodiment which is here not shown in more detail, air is filtered in the area between the central air distributor 22 and a vacuum-generating means, in particular directly in front of a vacuum pump, by means of a central air filter.

In a further embodiment, which is also not shown, at least some of the individual suction plunger means 13 are connected via individual feed lines to a source of vacuum. The actuation of the suction plunger means 13 with vacuum is controlled via a valve assembly, preferably solenoid valves, in particular in combination with throttle means.

The joined articles A are transferred from the assembling head 12 in the discharge position to a discharge wheel 3 and handed over by said wheel to a carrier chain 20 which supplies the articles A to a packing machine, in particular a flow pack machine (tubular-bag packing machine). Prior to packing of the articles A, a quality control is carried out, preferably by means of an image processing system (not shown), using a plurality of evaluation criteria, with an article being sorted out if at least one of the evaluation criteria has not been satisfied. The evaluation criteria include at least the presence of both components in the article, a positioning of the second component in the recess of the first component, intactness of the first component and intactness of the second component. Thus, if at least one of the above-mentioned features is not realized, the corresponding article A will be removed from the system prior to packing.

The articles A pass by means of the carrier chain 20 in a correct position into a film tube formed in the flow pack machine, which is longitudinally and transversely sealed and separated, whereby the article A is packed. The empty packages which are obtained due to the sorting out of defective articles A are sucked off.

The above-described preferred embodiment reveals a method for assembling and packing small-sized articles A consisting of at least two components K1 and K2. A first component K1 is here supplied to a handling device 1; a second component K2 is assigned to the first component K1. The article A which has been assembled from the first and second components K1, K2 is subsequently packed. Being held between an input and discharge position by the handling device 1, the first component K1 is guided by controllable pairs of gripper means 2 along a curved path, the first component K1 being received at the input position, guided along the curved path and transferred at the discharge position by the pairs of gripper means 2 of the handling device 1 to a transfer means 3. The second component K2 is also supplied to the handling device 1, isolated and connected to the first component K1.

In the described preferred embodiment of the method for assembling and packing small-sized articles A, the first components K1 are supplied in series, preferably in a proper position on a transportation belt, and accumulated on an accumulation belt of a feeding and synchronizing system and then synchronized with a graduation of an input means 4 and transferred in spaced-apart relationship with one another.

In a further preferred step of the method, recesses 5 which are formed in the first components K1 for receiving the second components K2 are provided with an adhesive after synchronization with the input means 4 of the first components K1. The adhesive is preferably applied in response to a positional detection of the first component K1 by means of an optical sensor, in particular an edge sensor, for the first component K1 in combination with an incremental stepping means (not shown). In addition, the application of adhesive may be controlled, preferably by means of an infrared sensor, small-sized articles with an unsatisfactory application of adhesive of the first component being preferably sorted out prior to packing of the small-sized articles.

According to the described preferred embodiment, the second component K2 is supplied substantially radially with respect to the handling device 1 before being connected to the first component K1. In a further embodiment (not shown), the second component K2 is supplied to the handling device 1 substantially tangentially.

The supply of the second component K2 is preferably sensor-monitored, the system being stopped on the basis of signals from the sensors mounted on the supply rail 16 when a component flow in the supply rail 16 is interrupted.

According to the described step of the method, the second component K2 is received from an accumulation in the supply 6 to the handling device 1 by an isolating disk 7, which is rotating with the handling device 1, in pocket-shaped recesses 8 of said disk and thus isolated from the accumulation. Side surfaces of the isolating disk 7 which are at least temporarily in contact with the second components K2 are here preferably shaped such that the second components K2 are conveyed quasi-continuously.

The isolated second components K2 are preferably sucked via a suction means 9, inserted into the recess 5 of the first component K1 and inseparably connected to said component K1. According to the described preferred embodiment of the method for assembling and packing small-sized articles A, a second component K2 is respectively inserted into a recess 5 of a first component K1.

According to said preferred embodiment, the article A is controlled after the assembling step and prior to packing by using a plurality of evaluation criteria, the articles being sorted out if at least one of the evaluation criteria is not satisfied. The preferably optical control is preferably carried out by means of an image analysis. The evaluation criteria include at least the presence of both components K1, K2 in the article A, a position of the second component K2 in the recess 5 of the first component K1, intactness of the first component K1 and intactness of the second component K2.

According to the above-described preferred embodiment, the apparatus for assembling and packing small-sized articles A consisting of at least two components K1 and K2 each comprises a first supply means 10 for the first component K1, a second supply means 11 for the second component K2, a handling device 1 for connecting the first component K1 to the second component K2, a transfer means 3 for the article A consisting of first and second components K1 and K2, and a subsequent packing means, in particular a tubular-bag packing means; wherein an assembling head 12 which is rotatable about an axis Z is here provided comprising a plurality of cam-controlled pairs of gripper means 2 arranged circumferentially in sequence, an isolating disk 7 with circumferentially spaced-apart pocket-shaped recesses 8 for receiving the second component K2 and suction plunger means 13 arranged in the area of each pairs of gripper means 2 and associated pocket-shaped recess 8. The suction plunger means 13 are here connected to a central vacuum distributor 22.

According to the preferred embodiment the apparatus for assembling and packing small-sized articles A consisting of at least two components K1 and K2 each comprises an input wheel 4, said input wheel 4 being arranged upstream of the assembling head 12 and in operative communication with an input chain 14 which supplies a plurality of the first components K1 to the input wheel 4. Each of the first components K1 is here spaced apart during transfer of the first components K1 by carriers 15 of the input chain 14 to the input wheel 4 and can be received with a precise positioning by the cam-controlled pairs of gripper means 2 of the assembling head 12.

An adhesive feeding means for introducing an adhesive agent into a recess 5 of each of the first components K1 is provided in the area of the input chain 14 or in the area of the input wheel 4 according to the described embodiments. A position sensor, in particular an edge sensor with incremental stepping means (not shown), which is arranged in the area of a drive (not shown) of the input chain 14 or the input wheel 4 is preferably provided for actuating an electrically operable application head for the application of adhesive.

An infrared sensor (not shown) which is arranged in the area of the input chain 14 or the input wheel 4 is preferably provided for controlling the application of adhesive in each recess 5 of the first component K1. An ejection means for first components K1 after assembly with the second component and prior to packing of the assembled article A is responsive to an output signal of the infrared sensor in the described preferred embodiment.

According to said embodiment of the apparatus for assembling and packing small-sized articles consisting of at least two components K1 and K2 each, the second component K2 can be supplied to a centrifugal conveyor from a belt bunker via an elevator, the elevator being controllable in response to a filling level of the centrifugal conveyor.

As described for the above embodiments, a preferably inclined supply rail 16 for radially or tangentially supplying the second component K2 to the assembling head 12 is provided in the area of the isolating disk. Sensors are here provided in combination with the supply rail 16 for monitoring the supply of second components K2, for controlling the centrifugal conveyor and the assembling head 12. The isolating disk 7 is exchangeably arranged on the shaft. A particularly pneumatically operated stopper is arranged directly upstream of the isolating disk 7 of the assembling head 12, the stopper being provided for interrupting a supply of the second components K2 to the assembling head 12, in particular in response to an operative state of the assembling head 12.

A substantially vertical movement of the described suction plunger means 13, in particular vertical suction plunger means 13, is preferably controllable by means of a cam 17. The cam 17 for moving the vertical suction plunger means 13 is preferably exchangeable.

According to the preferred embodiment a connection of the suction plunger means 13 to the central vacuum distributor 22 comprises at least one air filter 18. A constructional size of said air filter is adapted to the spatial conditions of the installation site.

According to a further embodiment, a central air filter of a larger dimension (not shown) is installed between the vacuum distributor 22 and a vacuum-generating means. Said central air filter is restricted by the constructional conditions of the installation site to a much lesser degree, whereby contamination and clogging effects of the central air filter are reduced considerably. It should be noted that a very high dust load arises while dish washer tabs are being packed.

It follows from the described preferred embodiment that a discharge wheel 3 is arranged downstream of the assembling head 12, the discharge wheel 3 being in operative communication with a further carrier chain 20 with side guides 21 for carrying away a plurality of the articles A from the discharge wheel 3. The discharge wheel 3 transfers each article A to carriers (not shown) of the carrier chain 20 in spaced-apart fashion to a downstream packing machine, the carrier chain 20 simultaneously representing the supply chain of the packing machine and being provided for supplying the articles A in a correct position to the packing machine.

The first component K1 is preferably a prismatic body with a recess 5 shaped in the form of a blind hole for receiving the second component K2. In this instance the second component K2 has an outer surface which is substantially shaped in rotational symmetry, in particular as a ball, cylinder or ellipsoid.

1. A method for assembling and packing small-sized articles (a) consisting of at least two components (K1, K2), a first component (K1) being supplied to a handling device (1), a second component (K2) being assigned to said first component (K1), and said article (a) being subsequently packed, characterized in that said first component (K1) is guided between an input position and a discharge position by said handling device (1) along a curved path, held by controllable pairs of gripper means (2), received in said input position, held along said curved path and transferred in said discharge position by said pairs of gripper means (2) of said handling device (1) to a transfer means (3), said second component (K2) is supplied to said handling device (1), isolated and connected to said first component (K1).

2. A method according to claim 1, characterized in that a plurality of first components (K1) are supplied in series in a proper position on a transportation belt and accumulated on an accumulation belt of a feeding and synchronizing system, and said first components (K1) are subsequently synchronized with a graduation of an input means (4) and spaced apart from one another.

3. The method according to claim 1 or 2, characterized in that recesses (5) of said first components (K1) are provided with an adhesive after synchronization of said components.

4. The method according to claim 3, characterized in that adhesive is applied in response to a positional detection of said first component (K1), in particular by means of an optical sensor, preferably an edge sensor, in combination with an incremental stepping means for said first component (K1).

5. The method according to claim 4, characterized in that the application of adhesive is controlled, preferably by means of an infrared sensor.

6. The method according to at least one of the preceding claims 1 to 5, characterized in that said second component (K2) is supplied substantially radially or tangentially to said handling device (1) prior to connection to said first component (K1).

7. The method according to claim 6, characterized in that a supply of said second components (K2) is sensor-monitored, the system being stopped on the basis of signals from sensors mounted on a supply rail (16) when a component flow in said supply rail (16) is interrupted.

8. The method according to any one of claims 6 or 7, characterized in that said second component (K2) is received in pocket-shaped recesses (8) of an isolating disk (7), which is rotating with said handling device (1), from an accumulation in the supply (6) to said handling device (1) and is isolated from said accumulation.

9. The method according to claim 8, characterized in that a side surface of said isolating disk (7) which is at least temporarily in contact with said second components (K2) is shaped such that said second components (K2) are conveyed quasi-continuously.

10. The method according to at least one of the preceding claims 6 to 9, characterized in that said second component (K2) is sucked via a suction means (9), inserted into a recess (5) of said first component (K1) and inseparably connected thereto.

11. The method according to at least one of the preceding claims 7 to 10, characterized in that one second component (K2) is, respectively, inserted into the recess (5) of a first component (K1).

12. The method according to at least one of the preceding claims 1 to 11, characterized by an optical control of said article (A) prior to packing using a plurality of evaluation criteria, with an article being sorted out if at least one of said evaluation criteria is not satisfied.

13. The method according to claim 12, characterized in that said optical control is carried out by means of an image analysis.

14. The method according to any one of the preceding claims 12 or 13, characterized in that said evaluation criteria include at least the presence of both components (K1, K2) in said article (A) and/or a position of said second component (K2) in said recess (5) of said first component (K1) and/or intactness of said first component (K1) and/or intactness of said second component (K2).

15. An apparatus for assembling and packing small-sized articles (A) consisting of at least two components (K1, K2) each, comprising a first supply means (10) for said first component (K1), a second supply means (11) for said second component (K2), a handling device (1) for connecting said first component (K1) to said second component (K2), a transfer means (3) of said article (A) consisting of first and second component (K1, K2), and a subsequent packing means, in particular a tubular-bag packing means, characterized by an assembling head (12) which is rotatable about an axis (Z) and includes a plurality of cam-controlled pairs of gripper means (2) arranged circumferentially in sequential order, an isolating disk (7) comprising circumferentially spaced-apart pocket-shaped recesses (8) for receiving said second component (K2) and suction plunger means (13) which are arranged in the area of each pair of gripper means (2) and associated pocket-shaped recess (8), each of said suction plunger means (13) being connected to a central vacuum distributor.

16. The apparatus according to claim 15, characterized by an input wheel (4) upstream of said assembling head (12), said wheel being in operative communication with an input chain (14) which supplies a plurality of said first components (K1) to said input wheel (4), each of said first components (K1) being transferred in spaced-apart relationship by carriers of said input chain (14) to said input wheel (4) and being receivable with a precise positioning by the cam-controlled pairs of gripper means (2) of said assembling head (12).

17. The apparatus according to any one of claims 15 or 16, characterized in that an adhesive supplying means is provided in the area of said input chain (14) or said input wheel (4) for introducing an adhesive into a respective recess (5) of said first component (K1).

18. The apparatus according to claim 17, characterized in that a position sensor, in particular an edge sensor, is provided in the area of a drive of said input chain (14) or said input wheel (4) in combination with an incremental stepping means for actuating a particularly electrically operable application head for the application of adhesive.

19. The apparatus according to any one of claims 17 or 18, characterized in that an infrared sensor is provided for controlling the application of adhesive in said recess (5) of said first component (K1) in the area of said input chain (14) or said input wheel (4).

20. The apparatus according to at least one of the preceding claims 15 to 19, characterized by an ejection means for first components (K1) in response to an output signal of said infrared sensor, an ejecting operation being carried out in particular downstream of said assembling head and upstream of a packing means.

21. The apparatus according to at least one of the preceding claims 15 to 20, characterized by a belt bunker for said second component (K2) and by an elevator for supplying said second component (K2) to a centrifugal conveyor, said elevator being controllable in response to a filling level of said centrifugal conveyor.

22. The apparatus according to claim 21, characterized by an inclined supply rail (16) for supplying said second component (K2) radially or tangentially to said assembling head (12) in the area of said isolating disk (7).

23. The apparatus according to at least one of the preceding claims 15 to 21, characterized in that said isolating disk (7) is exchangeably arranged on a shaft.

24. The apparatus according to at least one of the preceding claims 15 to 23 characterized by a stopper which is arranged directly upstream of said isolating disk (7) of said assembling head (12) and is operated in particular pneumatically, said stopper being provided for interrupting a supply of said second components (K2) to said assembling head (12), in particular in response to an operative state of said assembling head (12).

25. The apparatus according to at least one of the preceding claims 22 to 24, characterized by sensors in combination with the inclined supply rail (16) for monitoring the supply of second components (K2), for controlling said centrifugal conveyor and said assembling head (12).

26. The apparatus according to at least one of the preceding claims 15 to 25, characterized in that a cam (17) is provided for controlling the substantially vertical movements of said suction plunger means (13), in particular vertical suction plunger means (13).

27. The apparatus according to claim 26, characterized in that said cam (17) for moving said vertical suction plunger means (13) is exchangeable.

28. The apparatus according to at least one of the preceding claims 15 to 27, characterized in that a connection of said suction plunger means (13) to said central vacuum distributor (223) comprises at least one air filter (18), or a connection of said central vacuum distributor (22) to a vacuum-generating device comprises a central air filter.

29. The apparatus according to at least one of the preceding claims 15 to 28, characterized in that said first component (K1) is designed as a prismatic body with a recess (5) shaped in the form of a blind hole for receiving said second component (K2).

30. The apparatus according to at least one of the preceding claims 15 to 29, characterized in that said second component (K2) has an outer surface substantially shaped in rotational symmetry, in particular as a ball, cylinder or ellipsoid.

31. The apparatus according to at least one of the preceding claims 15 to 30, characterized in that a discharge wheel (3) is arranged downstream of said assembling head (12), said discharge wheel (3) being in operative communication with a carrier chain (20) carrying away a plurality of said articles (A) from said discharge wheel (3), said discharge wheel (3) transferring each article (A) to carriers of said carrier chain (20) in spaced-apart relationship.

32. The apparatus according to claim 31, characterized by a packing machine, said carrier chain (20) being provided for supplying said articles (A) in a correct position to said packing machine.
